(19) United States
(12) Patent Application Publication
(10) Pub. No.: US 2007/0266147 A1
(43) Pub. Date: Nov. 15, 2007

(54) Knowledge acquisition system for remotely managed client computer

(76) Inventor: Aynov Tanaka, San Jose, CA (US)

Correspondence Address: KAPLAN GILMAN GIBSON & DERNIER L.L.P., 900 ROUTE 9 NORTH, WOODBRIDGE, NJ, 07095, US

(21) Appl. No.: 11/433,786

(22) Filed: May 12, 2006

(51) Int. Cl. G06F 15/173

(52) U.S. Cl. 709/224

(57) ABSTRACT

A method is disclosed whereby parameters on a client computer are filtered, and those relevant to a remote IT manager are displayed and/or transmitted to a remote IT manager server. The system provides a concise listing of parameters of interest to an IT manager.

### TECHNICAL FIELD

This invention relates to computers, and more specifically, to an improved technique for managing a network of client computers.

### BACKGROUND OF THE INVENTION

Some businesses employ an outside information technologies (IT) management firm for maintaining, updating and generally managing the computer network of the organization. In such arrangements, often the outside IT manager employs a set of servers and its own software for keeping track of the operation of the variety of client computers. These IT manager servers are responsible for communicating with the client computers to ensure the correct applications are installed and updated, and that the client computers operate correctly.

In order for the IT manager to properly manage all of the software and hardware distributed and residing on each client, the IT manager may require certain tools and software to be resident on the client computers. Additionally, several parameters of the client computer's configuration may be required by the IT manager to be set in specific manners.

Although the IT manager servers are aware of the various configurations and software on each of the client computers, and many of the associated parameters, many other parameters may be unique to, or configurable by, the various client computer users. As a result, there are a variety of configurable parameters of the client computer, a subset of which are either relevant, important, or actually mandated by IT manager servers, and many of which are typically just individual preferences that need not be managed or set by the IT manager server.

Most operating systems have the capability for a user to inspect the configuration of the computer. For example, Microsoft Windows provides a manner in which to determine which applications are installed or running, the IP address of the computer, etc. Notably, however, the configuration of the client computer may involve hundreds or possibly even thousands of parameters. Accordingly, an outside IT manager must sift through a variety of programs and screens of the client computer to view the parameters he desires, to test if the appropriate tools are installed, and to otherwise ensure that the client computer is correctly configured for the IT management.

There exists a need in the art for a more efficient manner in which to configure and verify client computers when under the jurisdiction and management of a remote IT manager server.

There also exists a need in the art a need for a streamlined methodology to extract and present the relevant configuration and other parameters to, for example, an outside IT manager.

### BRIEF DESCRIPTION OF THE DRAWINGS

FIG. 1 is a conceptual diagram of a network having an outside IT manager computer and several client computers;

FIG. 2 is an overview of several screen shots that could be generated in accordance with an exemplary embodiment of the present invention;

FIG. 3 is an additional screen shot giving status of certain IT manager installed software packages;

FIG. 4 is an additional screen shot showing certain applications from the IT manager as well as those already present on the client computer;

FIG. 5 is an additional screen shot showing a subsection of applications normally viewable in the operating system “add/remove” program;

FIG. 6 shows some additional connectivity screen shots that may be generated by an exemplary embodiment of the present invention; and

FIG. 7 is some compiled configuration information generated by an embodiment of the present invention.

### DETAILED DESCRIPTION OF THE PREFERRED EMBODIMENT

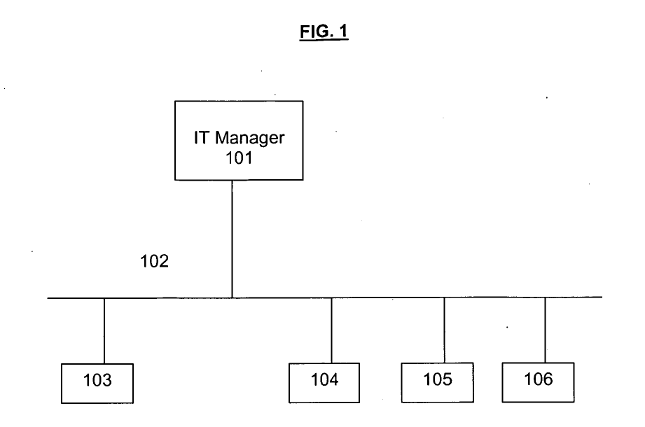

FIG. 1 shows a generic configuration of a system of client computers 103-106 connected to a network 102. Also shown is an IT manager 101, which is shown as one block for explanation purposes only. It is understood that the IT manager 101 may be a set of one or more servers that may be collocated with each other or remote from one another. Additionally, while the IT manager 101 is shown as directly connected to local area network (LAN) 102, the IT manager 101 may also be separated from LAN 102 via the internet or other wide area network.

Typically, the IT manager 101 is responsible for providing, updating and maintaining all of the client computers 103-106. This includes software distribution, problem monitoring, ensuring a common set of software among the client computers 103-106, and other maintenance functions. IT manager 101 communicates with client computers 103-106 that may install software, check status, etc. In order to provide such functionality, when the client computers 103-106 are brought online and under the management of IT manager 101, there are a variety of parameters, tools and other items that must be installed, configured, tested and verified.

While the operating system or other utilities provide a certain testing, measurement and display of various parameters, there is no known convenient way for IT manager 101 to access the operating state of configuration of the client computers. In accordance with the present invention, the utilities present within the operating system or other applications or software present on the client computers is queried, and the relevant information necessary for IT manager 101 is parsed out. That information may then be displayed in a variety of formats on the client and/or IT manager server 101.

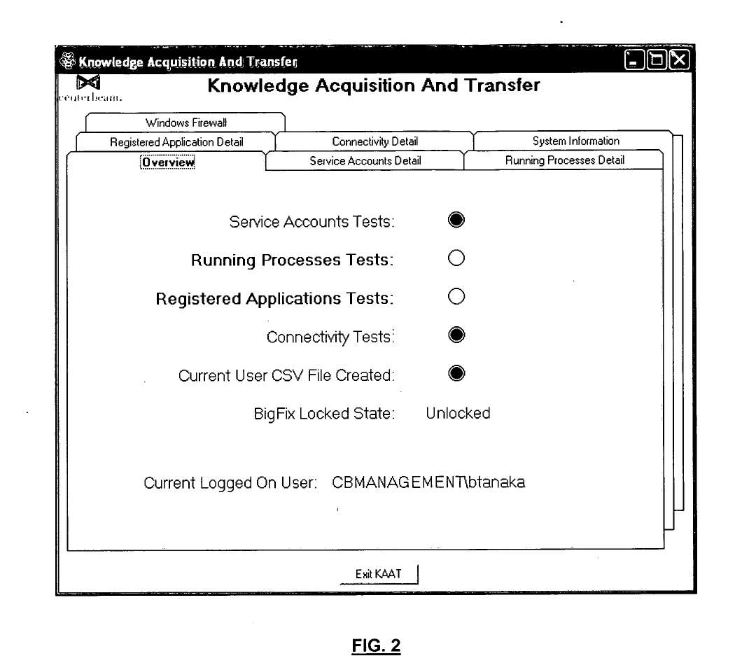

FIG. 2 shows an example of a “screen shot” in accordance with the present invention. The overview screen of FIG. 2 depicts several parameters which represent tools or other software installed by the IT manager 101 on the client. Essentially, this screenshot is a summary of the detailed information contained in the subsequent screen shots.

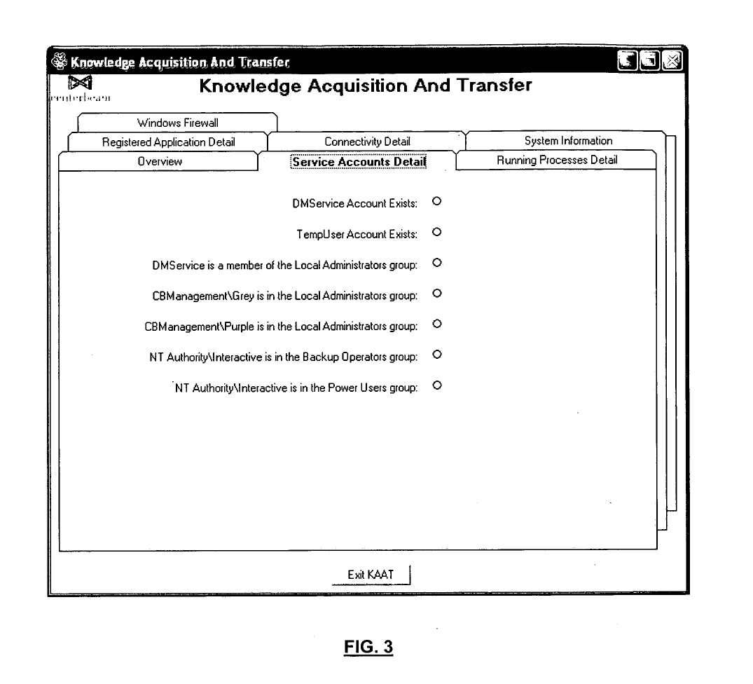

FIG. 3 depicts a service accounts detail screen, which lists the parameters of the client computer that should be set correctly in order to invoke the services of IT manager 101. The information displayed on FIG. 3 includes properties with respect to accounts installed on the client by the IT manager. The first two entries in FIG. 3 verify that such accounts have been installed. These first two accounts, DMService and TempUser, are utilized in one embodiment of the invention.

The DMService account is a local account used to perform tasks which require elevated permissions, such as installing software or changing Windows settings. This account normally is used by automated tasks. The TempUser account is used by support personnel. If an end user is unable to log into Windows, this account will give them a logon, and the ability to start the troubleshooting process.

A check is made to ensure the following accounts or Windows Global groups are members of the local system's Administrators group. This membership ensures that the accounts have elevated privileges on the system. By embedding global groups, there is an ability to audit who has accessed the system with elevated privileges. NT Authority\Interactive is placed in the Power Users and Backup Operators group as a best practice. This is a generic Microsoft Windows way of representing the current logged on user.

Other parameters displayed on FIG. 3 indicate whether certain accounts that have been set up are members of particular logical groups having properties that the IT manager has determined they should have.

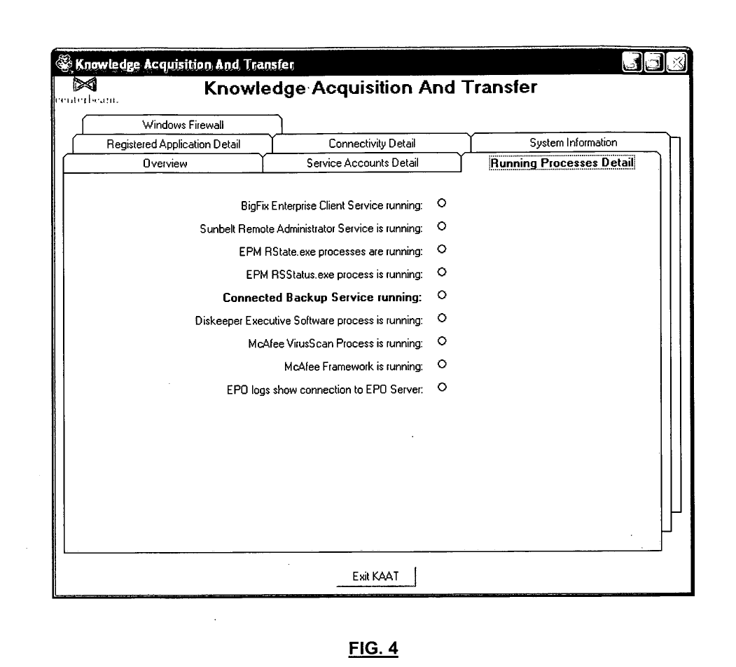

FIG. 4 represents a hybrid screen for displaying the test results of several different types of processes. A subset of the processes displayed in the screen shot of FIG. 4 are processes that have been installed by the IT manager, while others are those that have been independently installed on the client computer. The IT manager installed the appropriate software to run these processes on the client computer, then checks for the installation of other processes that should have been independently installed on the client computer, and displays the appropriate combination of both. Along with each process, there is an indication as to whether it is properly running in the form of a displayed bullet as shown in FIG. 4.

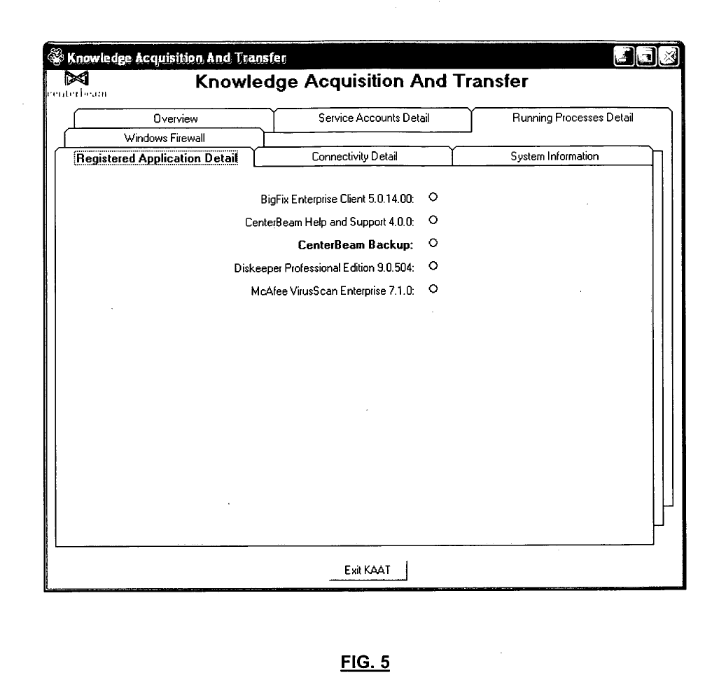

FIG. 5 depicts a set of programs which would otherwise be displayed by Microsoft Windows' “add/remove” menu. Specifically, the operating system of the client computer contains utilities to view particular software items that may be added or removed. However, rather than viewing all of those utilities, the additional software provided herein filters the utilities so that only those that the IT manager has predetermined are relevant to remote management are captured and displayed on the screen.

The client computer stores a file or other type of data structure that indicates the subset of parameters that are available in the operating system that are relevant or desired by the IT manager server. Then, the parameters are extracted via a separate tool from those ascertained by the operating system, and the extracted files may be displayed, as shown in FIG. 5, or even transmitted to a remote location.

An example of the display of such a subset of parameters is shown in FIG. 5.

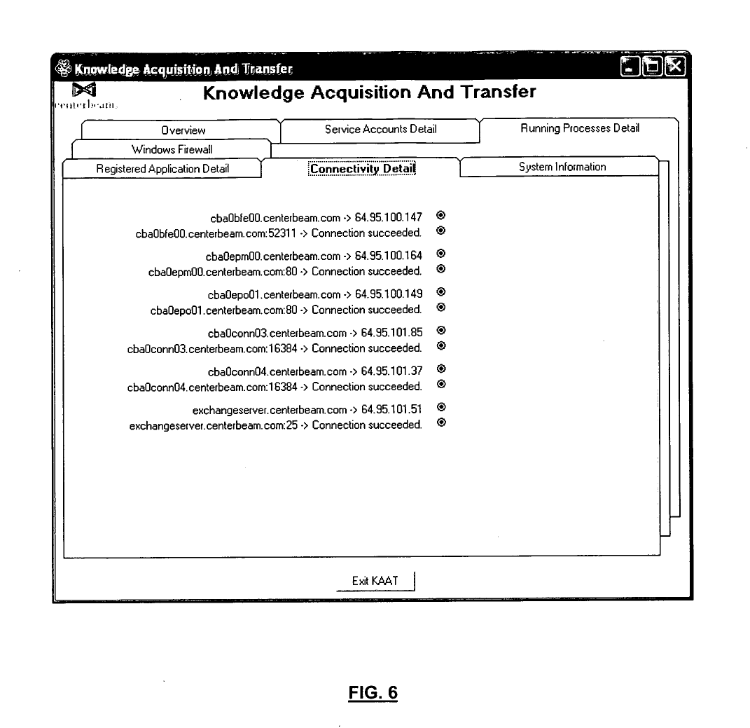

FIG. 6 depicts several tests that have taken place in a prescribed IT manager server to insure that the client computer is correctly connected thereto. After installation of the client software by the IT manager, a variety of connections are tested as shown and indicated to be successful so that the client, on the proper port, is connected to the proper IT manager server for testing, distribution of new software, etc.

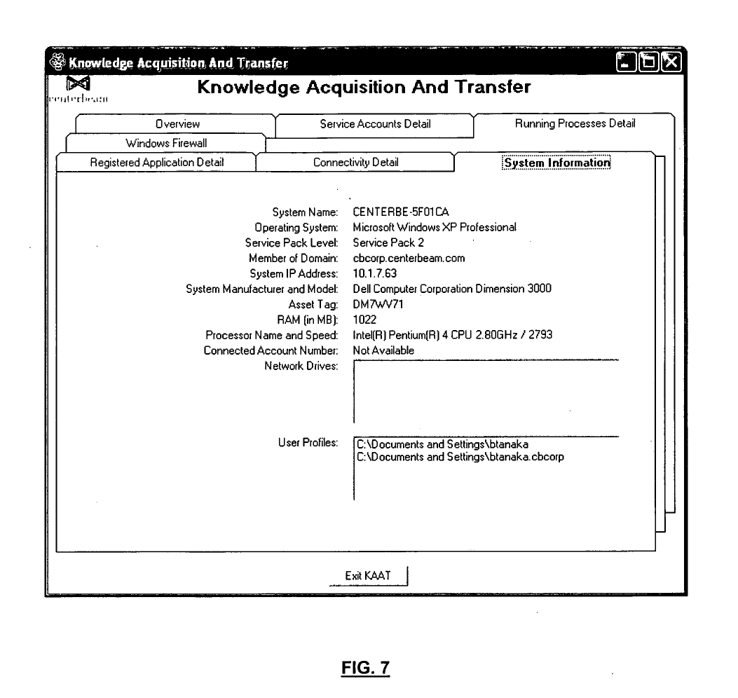

FIG. 7 shows some additional information concerning system configuration for the client computer.

With respect to the screen shots depicted in FIGS. 2-7, the parameters displayed may be any combination of software installed by the IT manager or software already resident on the client computer. Additionally, the configuration parameters typically displayed by an operating system or other application may be filtered so that only those important or relevant to the IT manager are displayed. Thereafter, the filtered parameters may be transmitted to the IT manager server, so that the personnel responsible at the IT manager can ascertain problems, determine the operational state of the client computer, etc.

The invention herein contemplates that many of the parameters important to the IT manager may be available for viewing by utilizing different functions of the client computer's operating system and/or applications software. In accordance with the present invention, the software tool installed by the IT manager will navigate through the various aspects of the client computer's operating system and applications software where a variety of parameters are available, filter them to parse out those in which the IT manager is interested, and then display the filtered parameters and/or optionally, convey them to a remote location.

While the foregoing describes the preferred embodiments of the invention, various other embodiments are possible and the examples given above are not intended to limit the following claims in any way.

1. A method of managing a set of networked client computers, said method comprising determining a first set of parameters necessary to be monitored, executing an operating system on at least one of said client computers, said operating system capturing a second set of parameters, automatically filtering said second set of parameters to parse out said first set of parameters, and displaying said first set of parameters.

2. The method of claim 1 further comprising transmitting said first set of parameters to a remote server after said first set of parameters is filtered from said second set of parameters.

3. The method of claim 2 wherein at least some of said first set of parameters are indicative of the operability of software transmitted to a client computer from a remote server.

4. The method of claim 2 further comprising ascertaining whether data connections to specified servers are operational, and displaying a status associated with each.

5. A computer system comprising an operating system including software for monitoring and displaying certain parameters related to the operation of said computer system, a file containing information requested by a remote IT manager, and software for interfacing to the operating system and filtering said certain parameters monitored by the operating system so that only parameters indicative of said information requested are monitored and displayed, and any remaining parameters related to operation of said computer system are not displayed.

6. The computer system of claim 5 wherein said parameters indicative are transmitted automatically to a remote IT manager server.

7. A method comprising installing a software tool onto a client computer, said client computer having an operating system, said operating system having various functions for making available for viewing various parameters associated with the configuration and operation of the client computer, utilizing said software to invoke a plurality of said functions to obtain said parameters, filtering said parameters to parse out those predetermined to be of interest to a remote IT manager, and displaying said parsed parameters.

8. The method of claim 7 wherein said software tool is installed from a remote location.

9. The method of claim 7 wherein said client computer also includes applications software, and wherein said software tool obtains and filters parameters associated with said applications software as well.

10. The method of claim 7 wherein said parsed parameters are also transmitted to a remote location.
